(19) United States
(12) Patent Application Publication
(10) Pub. No.: US 2022/0092505 A1
(43) Pub. Date: Mar. 24, 2022

(54) SYSTEMS AND METHODS OF PROVIDING FACILITY MANAGEMENT

(71) Applicant: Retrolux, LLC, Boise, ID (US)

(72) Inventor: Leif Eric Elgethun, Boise, ID (US)

(21) Appl. No.: 17/031,636

(22) Filed: Sep. 24, 2020

(51) Int. Cl. G06Q 10/06; G06Q 10/10; G06Q 10/08; G06Q 30/06; G06Q 50/16; G06Q 10/00; G05B 19/406; G06T 11/00

(52) U.S. Cl. CPC G06Q 10/06375; G06Q 10/067; G06Q 10/103; G06Q 10/0875; G05B 2219/24015; G06Q 50/163; G06Q 10/20; G05B 19/406; G06T 11/00; G06Q 30/0631

(57) ABSTRACT

Systems and methods of facility management are disclosed wherein data related to a facility are acquired from a plurality of sources, a proposal is generated related to maintaining, upgrading, modifying, etc. the facility and presented to an appropriate decisionmaker. The data underlying proposal comprises historical data, operational data, climate data, installed facility items data, candidate facility items, financial data related to operation, maintenance, etc. A digital representation of the facility is generated. Data related to the facility are aggregated over time to facilitate updating the digital representation and presenting the digital representation and related information to the decisionmaker, receiving approval from the decisionmaker, providing relevant portions of the digital representation and related information to contractors and vendors, and acquiring real time or near-real time updates related to implementation of the proposal to render updates to the digital representation and related information.

### TECHNICAL FIELD

The present disclosure relates generally to the field of building and facility management systems and methods. More specifically, the present disclosure relates to management systems and methods directed toward replacing, upgrading, and otherwise managing elements of a building or other facility.

### BACKGROUND

Buildings and other facilities are constructed with components existent at the time of construction. Components of a building or a facility, such as those associated with lighting, heating, air conditioning, ventilation, plumbing etc., over time may become outdated, may fail, or may otherwise become in need of maintenance or replacement. Similarly, cost of operation of such components may increase over time due to age of the components or infrastructure of the building or facility. Certain embodiments of the present disclosure can address one or more of the foregoing issues.

### SUMMARY

The present disclosure provides systems and methods to monitor and/or inform (e.g., a building and/or facility owner or manager, service providers, vendors) about a current status of components of a building/facility.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiment and are, therefore, not to be considered limiting of the scope of the disclosure, the embodiments will be described and explained with specificity and detail in reference to the following accompanying drawings.

FIG. 1 is a relational diagram of a facility management system, according to an embodiment of the present disclosure.

FIG. 2 is a more detailed relational diagram of the facility management system of FIG. 1.

FIG. 3 is a flowchart illustrating a method of operation for the facility management system of FIGS. 1 and 2, according to an embodiment of the present disclosure.

FIG. 4 is a flowchart further illustrating the method of operation for the facility management system of FIGS. 1-3, according to an embodiment of the present disclosure.

FIG. 5 is a logical communication diagram for a facility management system, according to an embodiment of the present disclosure.

### DETAILED DESCRIPTION

A facility can be a complex combination of components and sets of components (or systems) that require ongoing maintenance and upkeep to perform well and/or efficiently. Presently, the manner that facilities managers maintain facilities is a rather linear process that involves recognizing a potential facility project (e.g., a replacement or upgrade), requesting or otherwise receiving proposals, and using mostly ad hoc judgment to accept a proposal.

Currently, building and/or facility owners and/or managers can prospectively identify a potential facility project through reliance on information provided by a component manufacturer, when the component was installed or originally designed, and an estimated end of life. Such information, especially of the latter sort, may not reflect real-world operation, durability, life expectancy, etc., of the component. Presently available building/facility management software solutions may provide tools to track manufacturer data and “guestimate” life expectancy and optimal maintenance. However, these tools lack ability to provide actual operational status and lack perspective in the way of a cost-benefit analysis or estimated return on investment (“ROI”). Accordingly, a more common and perhaps de facto manner by which building/facility owner or manager may become aware of a need to maintain, replace, or update a component is when the component fails or is about to fail. Another way potential facility projects are identified is when a vendor or supplier raises awareness of a component's potential problem, such as through sales visits, marketing, and referrals to facility managers, all of which consume lengths of time.

Once a building/facility owner or manager is aware of a facility project need, a replacement component may be identified by, for example, simply replacing the old component with an identical-but-new component, or a more recent variant of the same component. A building/facility owner or manager may be unaware of upgrade possibilities, including the availability of any upgrade components, and also an effect of an upgrade on operating expense (and, hence, an ROI). Even a building/facility owner or manager who seeks to maximize the ROI may learn of potential upgrade components only by word of mouth (as from other building/facility owners or managers, or vendors). Even searching through publicly available information, such as on the Internet, is unlikely to inform the building/facility owner or manager of all available components and, perhaps more importantly, the suitability of upgrade components for the particular building/facility and risk tolerance of the building/facility owner or manager. Once a building/facility owner or manager elects to replace or upgrade a component (or system of related components), current technology does not provide a ready means for managing the selection of components, installers or contractors, compliance, provisioning of provisionable components, and updating appropriately any building/facility management system. Furthermore, a system does not exist which may monitor the real-world performance of the installed replacement or upgrade components in the particular building/facility so that realization of the expected ROI, and other metrics, can be ascertained, future replacement/upgrade programs may be planned and implemented, and aggregated performance can be used to anonymously (or otherwise) inform a decision regarding replacement or upgrade of similar such components in other buildings/facilities. In view of the foregoing issues and challenges, there may be notable desirability for systems and methods to better manage facilities.

As used herein, the term “structure” refers to any constructed or manmade structure having a generally fixed geolocation, and physical dimensions. Examples of a structure include, but are not limited to, a building (e.g., an office complex, a business center, a single family home, a single unit or set of units of an entire multi-unit residential structure, or the entire structure (e.g., apartment, townhouse condo), an emergency/medical services structure (e.g., firehouse, police station, hospital, etc.)), a recreational structure (e.g., park, urban trail or trail system, skating rink, skate park ball park, soccer field other sporting event structure, etc.), an entertainment structure (e.g., theater, professional sports arena, amphitheater etc.), a shopping structure (e.g., retail sales building, “big box” retail building, strip mall, mall, etc.), a transportation structure (e.g., urban transit centers, bus stations, train stations, railways, airports, harbors, bridges, etc.), a communication structure (e.g., network routing center, radio tower, cell tower, etc.), a farming structure, an irrigation structure (e.g., a canal, etc.), and an energy structure (e.g., transmission station, powerplant, dam, substation, nuclear reactor, etc.). For convenience of the disclosure, any erected or manmade “structure” can be encompassed within the description and considered a structure, as the term is used herein.

A facility may comprise a single structure, such as a building. A facility may comprise a set of structures. A facility may comprise a site (a location, such as a plot of land) on which a structure (or set of structures) may be erected. A facility may also comprise equipment installed or situated on a site of a structure and/or otherwise used in conjunction with a structure (e.g., heating, ventilation, and air conditioning equipment, machinery, forklifts, service vehicles, etc.). A complex facility can comprise a site (e.g., the land), one or more structures, and equipment associated with the land and/or structures.

As used herein, the term “facility item” refers to a component that may be installed to a facility, and is sufficiently broad to encompass things as simple or small as, for example, an attachment device (e.g., a screw, a bolt, a hanger, etc.) and things as complex as a “system” (e.g., ventilation system). The term “component” may be used in the present disclosure to represent a “facility item” such that the two terms are interchangeably used.

As used herein, the term “schedule” refers to a temporal arrangement of events, such as by time and date, or by sequential order of events with or without a particular time reference.

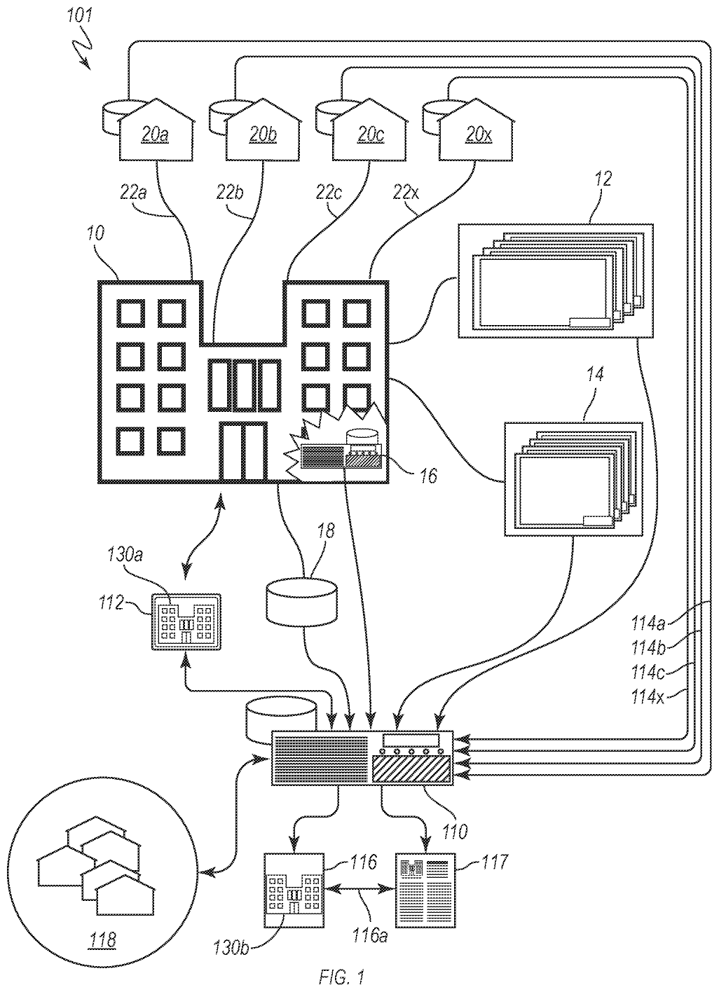

FIG. 1 is a relational diagram for a facility management system 101, according to an embodiment of the present disclosure. The facility management system 101, may, in some embodiments, be thought of or primarily utilized to manage upgrades to a facility, which may be one of many advantages of the embodiments of the present disclosure over existing building management systems (“BMS”), which are also sometimes known as facility management systems (according to technology available prior to the present disclosure). For the sake of clarity, and to differentiate from previously available or existing facility management systems (and systems of facility management), the embodiment of the facility management system 101 (and embodiments of systems of facility management) is referred to at times in the description herein as an upgrade management system (“UMS”) 101. Though the description refers to an upgrade management system or UMS, this term is intended to refer to facility management systems and systems of facility management according to the present disclosure and capable of any (and potentially all) functionality described herein and is not limited to upgrades. Accordingly, reference to and description of the UMS 101 pertains to a facility management system according to an embodiment of the present disclosure.

The UMS 101 may aid in recognition of facility projects that can improve facility maintenance, efficiency, and/or operation and that can more expeditiously and efficiently introduce new technologies into a facility. The UMS 101 can speed market adoption of new technologies by identifying facilities that can take advantage of new technology, presenting high ROI proposals and supportable and accurate insight of these ROIs, facilitating installation of technology of accepted proposals, and monitoring operational performance of installed technology. Data gathered in this cyclical (rather than linear) process can be used to improve future identification of facility projects and proposals for the same.

A building 10 is shown in FIG. 1 and the building 10 may represent any facility, whether a structure, a site, equipment (in conjunction with the structure and/or site), and any combination thereof. For convenience, the disclosure addresses the facility as the building 10; however, the disclosure anticipates that any aspect of a facility is encompassed by the disclosure. For example, the building 10 may represent multiple structures of a facility, and may further encompass equipment positioned on the site of the facility which may be external to a structure.

The building 10 may have been constructed according to a set of build plans 12. The build plans 12 may be obtained or otherwise received by the UMS 101 and may include map data of the building 10. The map data may include plan data providing a layout of the facility and relevant item data that provides one or more facility items, including a location of each facility item within the layout of the facility.

In the present example of FIG. 1, the building 10 may have undergone one or more renovations, upgrades, retrofits, etc., which may have been conducted according to one or more sets of update plans 14. The update plans 14 may also be obtained or otherwise received by the UMS 101 and may comprise additional map data, including plan data providing any updates to the layout of the facility and additional relevant item data that may provide any updates to the one or more facility items, including a location of each facility item within the layout of the facility.

The building 10 may be managed using and/or with aid of a BMS 16 (which may alternatively or in addition be known as a facility management system according to technology available prior to the present disclosure). The BMS 16 is shown in a cutaway of the building 10 for convenience of the disclosure and not by way of limitation. The BMS 16 may collect and provide BMS data to the UMS 101. The BMS data can include operational data (e.g., historical operational data providing historical operating conditions of the building 10 and/or current operational data providing current operating conditions of the building 10).

In addition to the build plans 12, update plans 14, BMS 16 data, an other information source 18 may also be available, wherein data regarding the building 10 may be found. The other information source 18 may be a single source of information or may comprise multiple sources of information. Examples, without limitation, of the other information source 18 may include a land survey, electronic map data (e.g., Google Maps™ mapping service), a photographic survey, an architectural article, court records, etc.

Where feasible, the UMS 101 may aggregate information regarding the building 10 from one or more of the build plans 12, the update plans 14, the BMS 16, and the other information source 18. More particularly, a facility management computing system 110 of the UMS 101 may acquire information regarding the building 10 from one or more of the build plans 12, the update plans 14, the BMS 16, and the other information source 18. As noted above, the information regarding the building 10 may include map data and operational data (historical operational data and live or present operational data). The map data and operational data may be converted into a digital representation of the building 10, as will be explained in greater detail below.

The building 10 may receive or consume services from one or more service providers 20a-20x. By way of non-limiting example, a first service provider 20a may supply electrical power to the building 10; a second service provider 20b may supply heating, ventilation, air conditioning (“HVAC”) service to the building 10; and a third service provider 20c may supply water to the building 10. Other services are also anticipated by the present disclosure, such as, e.g., network services, computing services, etc. Furthermore, in some embodiments, the building 10 may be supplied with a single service from multiple service providers 20a-20x. In one embodiment, the computing system 110 may acquire data regarding consumption of services from the service providers 20a-20x. For example, the first service provider 20a may provide (e.g., sell or otherwise deliver) 114a electrical consumption data about the building 10 to the computing system 110. Each service provider 20a-20x may provide 114a-114x to the computing system 110 data regarding consumption of the particular service by the building 10.

The UMS 101 may provide or otherwise employ a facility survey, which may be accomplished via a computing device, such as a tablet computer 112 (hereafter, “tablet 112”), a desktop computer, a mobile smartphone, a laptop, or other mobile computing device. While the description of FIG. 1 is reference to the tablet computer 112, it can be appreciated that substituted in place of the tablet computer 112 could be any one of a desktop computer, a mobile smartphone, a laptop, or other mobile computing device. The tablet 112 may be a portable, handheld computing device such as, e.g., an Apple iPad®, Samsung Galaxy Tab®, or the like. During the facility survey, information regarding the building 10 may be compiled with the tablet 112. The information regarding the building 10 may include map data, and more particularly item data, which may include information about facility items or components and may include one or more of a location within the facility of each component, a manufacturer and/or a model of each component, a number (e.g., a quantity) of each component, a condition of each component, service notes (such as how to access a component), etc. For example, without limitation, the facility survey may observe, and record to the tablet 112, the presence of each lighting system troffer in an area of the building; the manufacturer and model of each troffer; tubes, bulbs, arrays, etc. (including manufacturer and model information) installed to each troffer; physical condition (functioning, non-functioning, partially functioning, damaged, etc.) of each troffer and of each installed tube, bulb, array, etc.; and information on how to access a particular troffer if such would not be readily apparent, etc. The tablet 112 may communicatively connect (e.g., over the Internet or via wireless protocol) to the computing system 110 whereby data collected via the facility survey may be uploaded to the computing system 110. The data collected via the facility survey may be used by the UMS 101 to update a digital representation 130a (e.g., a digital twin) of the facility. The update of the digital representation 130a may update any one or more of a layout of the facility, facility item data, and present operating conditions of the facility.

A non-limiting example pertaining to a lighting system of the building 10 can further explain the interrelations in the diagram of FIG. 1. The first service provider 20a may provide electrical power to the building 10. The building 10 may comprise or have associated with it a system of electrically powered lighting, one or more computing systems, one or more computer networking systems, and other equipment that consumes electricity. The first service provider 20a may accumulate electrical power consumption data that is related (or relatable) to, for example, the electrically powered lighting system of the building 10. The computing system 110 may acquire or otherwise receive 114a the electrical power consumption data, such as from the BMS 16 or from the first service provider 20a. The computing system 110 may employ data from the tablet 112 acquired during the facility survey, and may further receive relevant item data for the lighting system from the build plans 12, the update plans 14, the BMS 16, and/or other information source 18. Each of these may comprise relevant item data pertaining to or regarding the specifications of the lighting system of the building 10. Lighting system specifications may include details such as identification of lighting components of the building 10. Identification of lighting components may include information such as mean time before failure (“MTBF”) provided by a manufacturer of the lighting component. If the information obtained from the build plans 12, update plans 14, BMS 16, and other information source 18 does not include MTBF, the UMS 101 may obtain MTBF data from one or more of a plurality of contractors and vendors 118. Furthermore, the update plans 14, the BMS 16, or other information source 18 may provide information relating to actual time between failures (“ATBF”) for the lighting component as installed and used at the building 10.

As further explained below, the UMS 101 may use relevant item data from the build plans 12, update plans 14, BMS 16, and other information source 18, along with actual power consumption data provided by the first service provider 20a and related/relatable to the lighting system of the building, along with MTBF and/or ATBF to create, update, or otherwise maintain a digital representation of the facility and forecast a future failure of a particular lighting component or plurality of lighting components. The future failure forecast, in turn, may serve to provide guidance in the form of a proposal comprising at least one recommendation, or a proposal comprising a set of one or more recommendations, regarding, improving, maintaining, replacing, upgrading, retrofitting, modifying, etc. the lighting system components. The digital representation of the facility and/or the recommendation may be useful to one or more of a facility manager, a decisionmaker, a vendor, a sales representative, or the like. Such digital representation and/or recommendation may be provided (e.g., incorporated into a prospectus 116) to assist with regard to an action to be implemented in relation to one or more facility items and/or the lighting system (or other systems) of the building 10. In other words, the prospectus 116 provided by the UMS 101 may comprise one or more of a digital representation 130b (e.g., a digital twin) of the building 10 and a proposal comprising a set of one or more recommendations. Each recommendation of a proposal can comprise an action to be implemented in relation to the one or more corresponding facility items and a value proposition for implementing the action. The prospectus 116 may permit a user to explore 116a additional information 117 and details related to the proposal, and to do so in varying degrees of detail. The digital representation and proposal are each discussed in greater detail below.

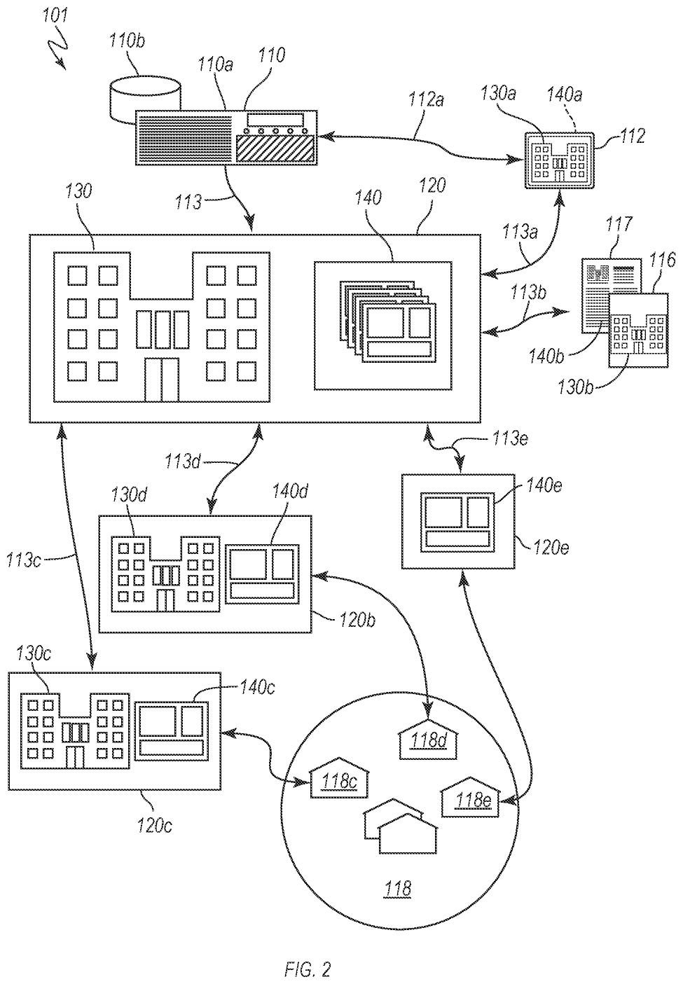

FIG. 2 is a more detailed relational diagram of the UMS 101 of FIG. 1. The UMS 101 includes the computing system 110 that receives data pertaining to a facility and generates and maintains one or more data structure 120 pertaining to the facility.

The computing system 110 comprises a computer 110a capable of reading and executing machine-executable instructions. The computer 110a may be a general purpose computer or server, or a plurality of such computers or servers (e.g., such as in a distributed computing environment, cloud computing environment, etc.). The computing system 110 comprises a communication network interface to communicate over a network with a facility and with various portions of the UMS 101. The computing system 110 further comprises a memory (e.g., a storage system) 110b. The storage system 110b comprises at least one non-transitory memory, such as a hard disk drive, a solid-state disk drive, a flash memory, an EPROM, an EEPROM, an optical disk drive, or other memory known in the art. The non-transitory memory is capable of storing machine readable and executable instructions, which may be in the form of a software application, a collection of related software applications, application programming interfaces (“APIs”), software modules, etc., as is known in the art. The storage system 110b may comprise multiple memories. The storage system 110b may be physically internal to the computer 110a in one embodiment. In one embodiment, the storage system 110b may be externally located to the computer 110a. In one embodiment, the storage system 110b may comprise a plurality of storage subsystems wherein one or more storage subsystems may be internal or external to the computer 110a. In one embodiment, the storage system 110b may be remote to the computer 110a or may comprise a storage subsystem that is remote to the computer 110a. The computing system 110 further comprises one or more processors capable of executing the machine executable instructions, and in electrical communication with the storage system 110b and to receive and transmit data via the communication interface. Execution of the machine executable instructions by the one or more processors may cause the one or more processors to perform operations to enhance facility management as described herein.

The computing system 110, using data acquired from one or more of build plans, update plans, BMS, other information source (see the build plans 12, the update plans 14, the BMS 16, the other information source 18 in FIG. 1), and from the site survey performed with or via the tablet 112, transforms 113 the acquired data about a building (e.g., the building 10 in FIG. 1) into new data and a new data structure 120 (or a revised data structure). The new data structure 120 can include two types of logical organization. A first logical organization may constitute a logical or digital representation (hereafter, “digital twin”) 130 of the building 10. A second logical organization may constitute a relational data structure (“RDS”) 140 containing data about systems, subsystems, components, etc., that are currently installed, or which may be candidates for installation at the building 10, financial data, build/component technical information (e.g., specifications), proposed installation schedules, and more. The new data structure 120 can also be an electronic prospectus 116, which may alternately or further comprise one or more proposals each including one or more recommendations pertaining to one or more corresponding facility items.

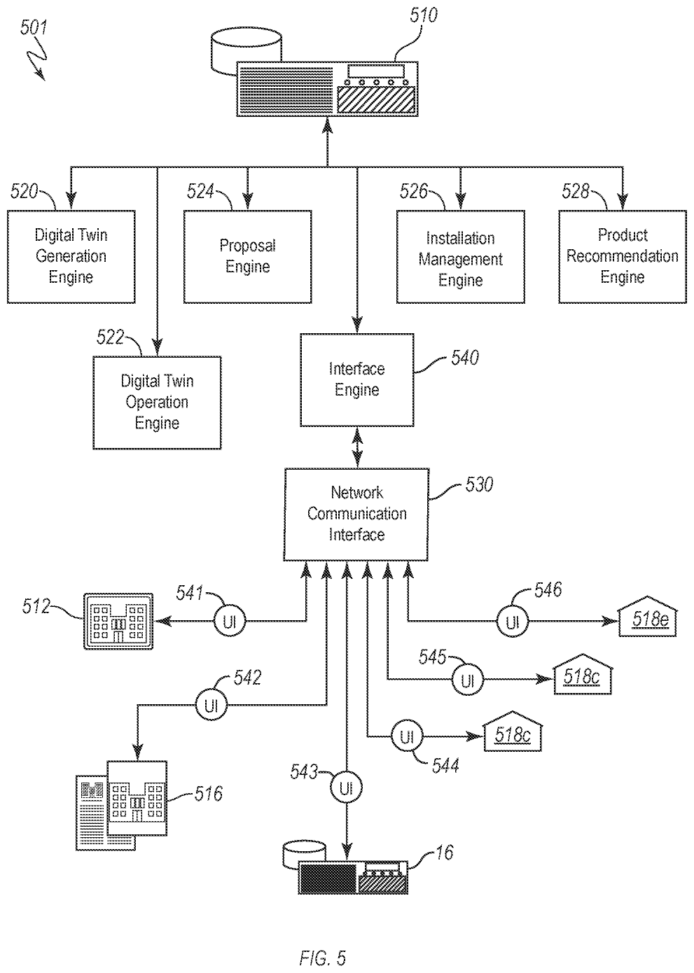

The computing system 110 receives, processes, and transforms data pertaining to a facility to generate and maintain the digital twin of a facility and to generate recommendations for the facility. The computing system 110 may include various components, engines, modules, or the like to accomplish various functions. For example, the computing system 110 may comprise a digital representation generation engine (hereafter, digital twin generation engine or “DTGE”) (e.g., the DTGE 520 in FIG. 5) to generate the digital twin 130, and a digital representation operation engine (hereafter, the digital twin operation engine or “DTOE”) (e.g., the digital twin operation engine 522 in FIG. 5) to facilitate updating the digital twin 130 and the RDS 140. The DTGE and the DTOE and any other components, engines, and/or modules of the computing system 110 may each comprise hardware and hardware logic at the computing system 110 and machine-readable and executable instructions by which data are parsed and processed to generate and update the digital twin 130.

The digital twin 130 comprises a digital representation of the facility. An objective or aim of generating and updating the digital twin is to provide an accurate, nearly accurate, and/or relevantly accurate digital representation of the facility. The digital twin is relevantly accurate when the components and/or systems relevant to a present consideration (e.g., a proposal, an analysis, a report, a presentation) are accurately present in the digital twin. For example, if a proposal is directed to a lighting system, or if a report on the operation of the facility is focused on a lighting system, then the digital twin is relevantly accurate if the lighting system facility items of the digital twin are complete, current, and accurate, notwithstanding information pertaining to the plumbing may be outdated or incomplete. As another example, for a building manager, an accurate digital twin includes accurate information for all systems and components the building manager has been tasked or otherwise determined to manage. A first digital twin of a first building of a first building manager may be accurate only if the paint on the walls is accurately represented in the digital twin, whereas a second digital twin of a second building of a second building manager may be accurate without any information about paint on the walls. In other words, “accurate” can encompass and be according to varying levels of completeness, according to perspective, need, situation, etc., and is not necessarily tied to or limited to a single uniform construct of completeness. A digital twin can be complete and accurate for one (or in a given situation or need) and may not be complete (and therefore not accurate) for another (or in a different situation or need).

The computing system 110 (e.g., a DTGE of the computing system 110), may receive map data of a facility (such as the building 10) to generate the digital twin 130. The map data can include plan data providing a layout of the facility and relevant item data that provides facility items, including a location of each facility item within the layout of the facility. The layout may comprise a floor plan of the building 10 and/or a reflected ceiling plan of the building 10. The layout may comprise a site plan for the site where the building 10 is located. The computing system 110 may be further configured to receive historical operational data providing historical operating conditions of the facility, including the one or more facility items. The operating conditions of the facility may include one of an actual operational cost of facility operation and data from which the actual operational cost of facility operation can be derived. The computing system 110 may convert the map data and historical operational data into the digital twin 130 of the facility. In some embodiments, the computing system 110 may also be configured to transform the digital representation of the facility into a design stage digital model of the facility (e.g., a building information modelling (BIM) asset). In some embodiments, the digital representation comprises a design stage digital model, such as a BIM asset.

The computing system 110 (e.g., a DTOE of the computing system 110) may be configured to receive live operational data (or present operational data) providing present operating conditions of the facility. Furthermore, the computing system 110 may update the digital twin 130 with the present operating conditions of the building 10 to ensure the digital twin 130 continues to accurately represent the facility. The computing system 110 may provide a visualization of the building 10 to a computing device of a user to present to the user the layout of the building 10, one or more facility items of the building 10, and operating conditions of the building 10. For example, the computing system 110 may provide the visualization of the building to the tablet 112. The visual representation may be rendered as a two-dimensional (2D) representation or a three-dimensional (3D) representation.

The digital twin 130 may be generated by the computing system 110 from data acquired from the sources detailed above. The digital twin 130 may constitute a logical representation of the building 10 and may be capable of rendering to a display of a computing device (or being rendered on a display of a computing device as) an image of the building 10. For example, the digital twin 130 may be used to render a visualization of the building 10 on the tablet 112. The rendering of the building 10 may take the form of line drawings, architectural-style drawings, or other visual representation. The digital twin 130 may comprise one or more photographs and/or videos of the building 10, portions of the building 10, systems, subsystems, and components of the building 10, etc. The digital twin 130 may be capable of rendering a navigable interface. The navigable interface may comprise a menu to permit a user to select from a plurality of views of the digital twin 130, such as, e.g., a front elevation, a side elevation, a back elevation, a floor plan of a floor, a perspective view, an orthogonal view, etc., and wherein each such view may represent the building 10 or a user-selected portion of the building 10. The navigable interface may permit a user to select a view incorporating a system or subsystem of the building 10. The navigable interface may permit a user to zoom in or out to view more detailed information, less detailed information, information of varying types, etc.

By way of example without limitation, the digital twin 130 may permit a user to view a front elevation representing the building 10. The user may select to view a line drawing. The user may select to view the front elevation in line drawing along with, for example, HVAC ducts. The user may select to view a floor plan of a particular floor, along with, for example, lighting troffers employed on the particular floor. The user may zoom in to obtain details regarding each troffer, or zoom out to view aggregate data regarding a plurality (or all) of the troffers for the particular floor. The digital twin 130 may permit the user to toggle between currently installed components and candidate components for installation. The user may, for example, select a troffer and view a photograph of the troffer that may have been taken during a facility survey. A view of a troffer may also display electrical load information for the troffer. Another view may display wiring used in the troffer, or proposed wiring. Another view may display conduits, tray routing, tray loading, wire detail, electrical loads, and more. The digital twin 130 may permit a user to conduct a logical “walk through” of the digital twin 130, displaying various renderings as the user “moves” through the digital twin 130, which may comprise line renderings, photographs, videos, technical data (for currently installed components or candidates for installation), and more.

The RDS 140 may be generated by the computing system 110 using information acquired from various sources as detailed above. The RDS 140, as its name suggests, may comprise at least one relational data structure. More particularly, the RDS 140 may comprise a plurality of tables. Each table may be linked to one or more other tables at one or more of the table level, a row level, a column level, an array level, or a cell level. In addition to data, the RDS 140 may comprise information to control rendering of data to a display (or printing) in a viewer usable manner. The RDS 140 may comprise: data about the building 10 itself as a whole, such as dimensions and materials of the building 10; data about systems and subsystems at the building 10, such as, e.g., electrical systems for lighting, computing, telephony, networking, etc.; and data about components of the facility, including components of systems and subsystems, such as, e.g., lighting installations (for example, troffers, pans, headers, floor lights, signage, etc.) and components installed to lighting installations, potentially with technical specifications of the components, etc. Furthermore, the RDS 140 data may comprise time-related information, such as build dates, renovations dates, ages of systems, components, etc., MTBF/ATBF information for installed systems and components, MTBF and estimated ATBF information for candidates for installation to the building, etc. Additionally, the RDS 140 data may comprise financial information related to historical operation of the building 10, and, more particularly, to the use and maintenance of currently installed systems and components, and forward-looking estimates regarding replacement of current system and components or upgrade to new systems and/or components, including estimated costs of continued operation in an as-is condition, and costs of renovation, upgrade, etc., along with forecasts related to cash flows and associated financial metrics such as ROI. The RDS 140 data may further comprise information regarding asset exchange values, such as, e.g., block purchase and exchange of electrical power, potentially as a quasi-currency.

A user of the digital twin 130 and/or the RDS 140 may be able to toggle between the digital twin 130 and the RDS 140. In one embodiment, the UMS 101 may permit rendering of at least a portion of the digital twin 130 simultaneously with some data from the RDS 140. By way of example without limitation, a user may be viewing the digital twin 130 and may select to view a rendering of the digital twin 130 with the current workspace lighting system. The user may select the current workspace lighting system and select to view financial data related to the workspace lighting system. The financial data may be a portion of the data of the RDS 140. The financial data may comprise historical cost of operation in aggregate, or based on a time period, or based on a physical portion of the building 10, etc. The user may toggle a view from visualization of the digital twin 130 to the financial data for the workspace lighting system as found in the RDS 140, and may also toggle back to the visualization of the digital twin 130. In one embodiment, the financial data from the RDS 140 may be displayable alongside the rendering of the digital twin 130. A user may also choose to toggle between a current installation to a proposed installation within the digital twin 130. Likewise, a user may toggle from financial data regarding a current installation to financial data regarding a proposed installation.

The UMS 101 may be configured to generate a single proposed installation or a plurality of proposed installations. Using the digital twin 130, a user may toggle between renderings of the current installation, between a particular rendering of the current installation and related rendering of a proposed installation, between various renderings of a proposed installation, and between renderings of various proposed installations. Furthermore, a user may toggle between various schedules of systems, subsystems, components of the current installation, or any generated proposed installation within the RDS 140. Similarly, a user may toggle between financial data of the current installation and that of any proposed installation within the RDS 140. The UMS 101 may also generate proposed installation schedules to assist in orderly execution of an installation or series of installations.

As previously discussed, a facility survey may be completed by a user using the tablet 112. The tablet 112 may communicate 112a with the computing system 110 to upload the facility survey (and particularly the data collected thereby) to the computing system 110.

The computing system 110 may also communicate 112a with the tablet 112 to download the data structure 120 generated by the UMS 101. For example, the computing system 110 may communicate or otherwise provide to the tablet 112 a child digital twin 130a (a complete or relevant partial replica of the digital twin 130) and a child RDS 140a (a complete or relevant partial replica of the RDS 140). The tablet 112 may be configured to capture input from a user related to the child digital twin 130a and the child RDS 140a, and to communicate 113a the input to the respective parent digital twin 130 and RDS 140. The data structure 120 downloaded to the tablet 112 may be a complete data structure 120 that may be utilized by the tablet 112 in absence of a communication link with the computing system 110, such as for collecting additional data pertaining to the facility (e.g., via a facility survey), providing accurate information about a facility to a user, and rendering a digital, 3D visualization of the facility.

The prospectus 116 is generated by the UMS 101 in conjunction with generating the new data structure 120. The computing system 110 of the UMS 101 may include a proposal engine (e.g., the proposal engine in FIG. 5) to generate a proposal for the building 10. The proposal may comprise one or more recommendations each pertaining to one or more corresponding facility items. Each recommendation may comprise an action to be performed with respect to the one or more facility items in implementing the proposal. The recommendation may comprise one or more of improving, enhancing, supplementing, upgrading, replacing, retrofitting, modifying, and maintaining the facility item to which the recommendation pertains. An action may comprise doing nothing (potentially because the component or facility item is performing nominally, within an optimal or desired state, etc.). The computing system 110 may be further configured to include in the proposal a value proposition for each recommended action of the proposal. The computing system 110 may be configured to compare the actual operational cost of facility operation to the value proposition for implementing the corresponding action. The computing system 110 may be configured to transmit the proposal to a point of contact for the building 10, such as an appropriate decisionmaker. The computing system 110 may generate a subsequent proposal based in part on information from comparing the actual operational cost of facility operation to the value proposition for implementing the action to improve a recommendation (which may include a value proposition for implementing an action) in the subsequent proposal. The computing system 110 may transmit a report to the point of contact (e.g., via an update to the prospectus 116, or separate communication) for the facility providing a result of the comparison of the actual operational cost of facility operation to the value proposition for implementing the corresponding action.

The proposal may take the form of or be included in the prospectus 116. The prospectus 116 may be an electronic document. The prospectus 116 can comprise an instance of the digital twin 130b derived from the digital twin 130, and additional information 117 from an instance of the RDS 140b derived from the RDS 140. The prospectus 116 may render (or enable rendering) to a display of a client computing device a visual representation of the instance of the digital twin 130b, or the additional information 117, and may be configured to permit a user to toggle between the instance of the digital twin 130b and the additional information 117. The instance of the digital twin 130b may enable and/or permit a user to navigate through the visual representation of the building 10 (e.g., to perform a “walk through), to view portions of the visual representation, and to cause a rendering of the visual representation, of one or more facility items or collections of facility items; etc. The additional information 117 may be similarly navigable in that a user may view select data from the instance of the RDS 140b rendered in a human-readable and meaningful at any or several levels of detail. More particularly, the instance of the RDS 140b may permit the additional information 117 to render to a display of a computing device a high level overview of the proposal (e.g., an actual operational cost of facility operation, which may comprises a sum of operational costs of all facility items), and to permit the user to “drill down” to particular levels of details with regard to, for example, particular recommendations of the proposal, financial records, financial reports, financial estimates, candidate components to replace current facility items, specifications of components, and more.

The prospectus 116 may be updatable by the computing system 110 whereby the current status of the building 10 and systems, subsystems, components, etc., associated with the building 10 are described with respect to their current operational state (as-is condition), and may include a proposal (or a plurality of proposals) to replace, renovate, upgrade, etc., one or more systems, subsystems, components, etc. The prospectus 116 may textually and visually illustrate advantages and benefits of a proposal. The prospectus 116 further comprises financial data to assist in reaching a business decision to implement a proposal. The financial data may comprise past costs associated with the as-is condition, such as ATBF, operating expenses, maintenance costs in the as-is condition, etc. The financial data may further comprise material costs, component costs, and installation costs for implementing a proposal, and, based on the building 10, ROI estimates.

The prospectus 116 may be communicated 113b, via a network connection or wireless connection, to an electronic computing device (e.g., a computer, a tablet computer, a smartphone, etc.) and may be rendered to a display of the electronic computing device. The prospectus 116 may further comprise a capability to capture input from a user, e.g., proposal approval, specifications for a component to be recommended, schedule approval, etc., and to communicate 113b such input to the computing system 110. When a user of the prospectus 116 is an appropriate decisionmaker for the building 10, and approves a proposal, or a portion of a proposal, the approved proposal or approved portion of a proposal effectively becomes an upgrade plan. It should be noted that the term “upgrade plan” is used for convenience of the disclosure to refer to an approval of at least one recommendation of a proposal whereby the recommendation is authorized to be implemented, and need not particularly represent an “upgrade” to a facility item, collection of facility items, etc.

With regard to components for potential use in replacing or upgrading a system or subsystem, the UMS 101 may aggregate data from a variety of sources. For example, the UMS 101 may acquire information about a component from the component manufacturer, or from a vendor of the component. The information about a component may comprise dimensional data, power consumption, installation instructions, MTBF, etc. The UMS 101 may acquire information about a component for potential use in a facility in conjunction with a present proposal, or a proposal related to another facility. Once the UMS 101 has acquired information about a component, the information may be retained within the UMS 101 for use with other proposals within the same portfolio as the building 10, or for other buildings unrelated to the building 10. A portfolio may refer to a plurality of buildings owned, operated, or managed by a common entity.

Furthermore, the UMS 101 may interpolate or apply the information acquired about a component to generate detailed installation plans for use of the component in the building 10. For example, if the information provides that a component may serve a particular volume of space, and may be installed in a series of up to five instances of the component, and a particular space of the building 10, based on this information, requires 20 components, the UMS 101 may generate an installation plan implementing four series installations of five components each, and may concurrently generate or update related financial tables. Each such installation plan may be reviewable and manually editable. By way of non-limiting example, a user with appropriate knowledge may adjust the four-by-five series plan to a five-by-four series plan, or to an in-parallel plan, or to use heavier gauge wiring, or to use longer screws, or to use stronger bolts, etc. The UMS 101 may be configured to accept the manual edits and to concurrently update related installation plans and financial data.

In the embodiment of FIG. 2, the plurality of contractors and vendors 118 is shown, comprising at least the first contractor 118c, the second contractor 118d, and the vendor 118e (collectively hereafter, 118x). The first and second contractors 118c, 118d may be engaged to implement a portion of an upgrade plan generated by the UMS 101 for the building 10. The vendor 118e may be engaged to provide components to be used in implementing a portion of an upgrade plan. Each contractor and vendor 118x may be exposed to a portion of the new data structure 120 relevant to the service or materials each contractor or vendor 118x is to provide. By way of non-limiting example, and for convenience of the disclosure, the first contractor 118c may be engaged to implement a portion of the upgrade plan related to 120V/30 A electrical lighting, and the second contractor 118d may be engaged to implement a portion of the upgrade plan related to 480V/200 A service utilities. The vendor 118e may be engaged to provide some of the components for either or both contractors 118c, 118d.

In the present example, the first contractor 118c may receive 113c a portion 120c of the new data structure 120. The portion 120c comprises a child digital twin 130c and child RDS 140c, each of which excludes data and information not relevant to the work to be performed by the first contractor 118c, and a proposed installation schedule that was generated by the UMS 101. The child digital twin 130c and the child RDS 140c descends from and inherits a set of information from the digital twin 130 and RDS 140. Similarly, the second contractor 118d may receive 113d a portion 120b of the new data structure 120 comprising a child digital twin 130d and RDS 140d limited to data relevant to the work to be performed by the second contractor 118d, and a proposed installation schedule that was generated by the UMS 101. The vendor 118e may receive 113e a portion 120e of the new data structure 120 comprising an RDS 140e, and a proposed delivery schedule for components to be provided by the vendor 118e. Because the vendor 118e is not performing work on the building 10, the vendor 118e may not need a child digital twin, such as the child digital twin 130c, or 130d. In an instance in which the vendor 118e does need a digital twin, one may be provided along with the RDS 140e and delivery schedule. It should be noted that information relevant to the work to be performed by the first contractor 118c may include a portion of the information relevant to the work to be performed by the second contractor 118d. In the present example, the first contractor 118c, during installation of new components, may need to connect a service line to a distribution panel being installed by the second contractor 118d in conjunction with a new power distribution system the second contractor 118d is installing. In this instance, the first contractor 118c would have such information related to the distribution panel necessary to accomplish connection to the distribution panel.

Similarly, in the present example, the vendor 118e may be providing troffers to be installed by the first contractor 118c, but may not be providing exit lighting. In this instance, information about exit lighting would not be provided to the vendor 118e unless some other condition warrants the disclosure.

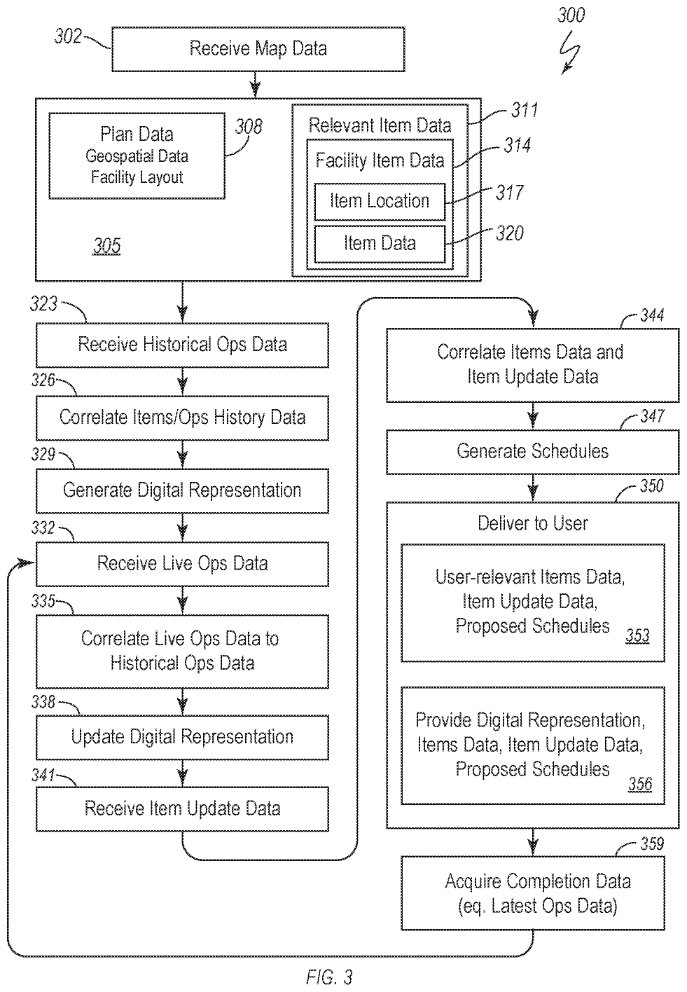

FIG. 3 is a flowchart of a method 300 of a UMS (e.g., the UMS 101 of FIGS. 1 and 2) of managing a facility, such as a building (e.g., the building 10 in FIG. 1). In general terms, the method comprises generating a proposal for a facility. The proposal can include a set of one or more recommendations each pertaining to one or more corresponding facility items. Each recommendation can comprise an action to be performed (or otherwise implemented) in relation to the one or more corresponding facility items and a value proposition for performing (or otherwise implementing) the action. The proposal can be transmitted or otherwise communicated to a human point of contact for the facility, a service provider, a vendor, etc. The method also can include capturing input from a human user and from other data sources to cyclically iterate through the method 300.

A UMS may receive 302 map data 305 for a facility. The facility may be an existing facility (i.e., a place comprising at least a physical structure constructed or otherwise installed for an activity or to serve a function), or may be a planned facility not yet constructed or installed. The map data 305 can include plan data 308 and relevant item data 311. The plan data 308 can include geospatial data (e.g., an address, global positioning system (GPS) locating data, climate data, etc.) and facility layout information (e.g., a site plan, exterior dimensions, interior dimension, location of interior walls, floor plan, reflected ceiling plan, etc.). The map data 305 may comprise a site map provided through the plan data 308 or the relevant item data 311, or both. The relevant item data 311 comprises facility item data 314 (e.g., item location 317 within/at the facility, item data/specifications 320 etc.). The relevant item data 311 comprises facility item data 314. The facility item data 314 may relate to facility equipment relevant to operation of the facility. Facility equipment may include fixtures (e.g., a lighting fixture, router, photovoltaic panel, etc.). The facility item data 314 comprises item location 317 (i.e., location of the facility item within/at the facility) and item data 320 (i.e., manufacturer, model, specifications from the item manufacturer describing the items physical and operational characteristics, information regarding installation of the item and/or integration to the facility or other facility items, etc.). The relevant item data for one or more facility items further includes operational system information describing a collection of facility items performing an operation of a facility (e.g., an HVAC system, waste water system, etc.). Said otherwise, the method 300 comprises receiving 302 map data 305 of an existing facility, which is a place comprising at least a physical structure (e.g., the building 10 of FIG. 1) constructed and/or installed for an activity or to serve a function. The map data 305 includes plan data 308 providing a layout of the facility and relevant item data 311 for one or more facility items, including a location of each of the one or more facility items within the layout of the facility.

The UMS may receive 323 historical operational data about the building 10 and a system and/or components of the system of the building 10. In other words, the method 300 comprises receiving historical operational data (e.g. usage; hours of operation, control schemes, energy consumption) providing historical operating conditions of the facility (potentially up to the present moment), including the one or more facility items (or components). The historical operational data may be received through collection or compilation of live operational data over time.

The UMS correlates 326 the historical operational data with the map data 305. This correlation 326 may be used to generate at least some of the financial data related to a system or components of the building 10. The UMS generates 329 a digital representation of the building 10 and systems and components. The generation 329 of the digital representation can include converting and/or otherwise processing the map data 305 and historical operational data into the digital representation of the facility. The digital representation is an accurate, logical representation of the building 10 in the as-is condition included in the map data 305 and the historical operational data.

Once the digital representation is generated 329, the UMS may proceed to receive 332 live operational data. The live operational data may comprise information regarding recent component replacements, and current costs of operation of the building 10, or a system, or components of the building 10. Stated otherwise, the method 300 comprises receiving live operational data providing present (e.g., current or updated) operating conditions of the facility.

The UMS may correlate 335 the live operational data with the historical operational data. This correlation 335 may generate a more accurate depiction of the financial effect of the as-is condition at present and going forward without implementing an upgrade plan. The UMS may update 338 the digital representation utilizing the live operational data by removing, replacing, and adding any components shown by the live operational data to have been removed, replaced, or added. The UMS may update 338 the digital representation of the facility with the present operating conditions of the facility (and the new designed/installed facility item) to ensure the digital representation continues to provide accurate representation of the facility. Based on the digital representation, the UMS may provide a digital 3D visualization of the facility to a user. The visualization can include rendering for the user the layout of the facility, the one or more facility items, and operating conditions of the facility.

The UMS may receive 341 item update data. The item update data may represent candidate components for replacing, upgrading, or augmenting current facility items at the building 10. The UMS may correlate 344 the item data 314 with the item update data to logically locate new components in the digital representation. The UMS may generate 347 schedules. Schedule generation 347 may comprise creation of data tables related to components to be installed, and generation of one or more proposed installation schedules.

The UMS may deliver 350 a collection of data (e.g., a digital representation, a child digital representation, a prospectus) to each user, and a user interface to facilitate rendering the collection data to a display of a client computing device and capturing input from a user of the client computing device. A user may be an owner, operator, or manager of the building 10, or of a portfolio to which the building 10 belongs; a contractor (see the plurality of contractors and vendors 118 in FIGS. 1 and 2, and the first and second contractors 118c, 118d in FIG. 2); a vendor (see the vendor 118e in FIG. 2), a sales representative; or another user designated within the UMS. The UMS may deliver 353 to each user a set of user-relevant item data, item update data, and proposed schedules, as further described in conjunction with FIG. 2. A user may further provide input via the user interface to, for example, select a product to be included as one of a new facility item or upgrade facility item in a proposal for the facility, enter data (i.e., specifications) for a facility item or upgrade facility item, approve a recommendation or proposal, modify or improve on a recommendation, etc. The UMS also provides 356 a digital representation (see the digital twin 130 and child digital twins 130c, 130d in FIG. 2), item data, item update data, and proposed schedules. The information provided may take the form of a prospectus (see the prospectus 116 in FIGS. 1 and 2).

The proposed installation schedule can be delivered to each contractor and vendor. Each contractor or vendor can accept the proposed installation schedule, may propose a new installation schedule, may decline the proposed installation schedule (which may include declining the install job), or (as appropriate) indicate completion or partial completion of the installation schedule to the UMS. The UMS can treat each acceptance, new proposal, decline, and completion as receiving 332 live operational data for the building 10. Once an installation schedule has been accepted, a contractor or vendor may request a modification. If the UMS receives an installation schedule modification request, the UMS may correlate the various installation schedules to assess the impact on each installation schedule, and may forward the update request, along with the impact assessment, to a relevant decisionmaker for action. Furthermore, the UMS may adjust one or more installation schedules based on the assessment, provided the adjustments fall within acceptable completion parameters.

When a contractor or vendor completes or partially completes an installation schedule, the contractor or vendor may provide completion data (as through an RDS). The UMS may acquire 359 the completion information. The UMS may handle the acquired completion information as receiving 332 live operational data. In other words, the UMS may update the new data structure such that the digital twin and RDS accurately reflect the new current state of the building 10.

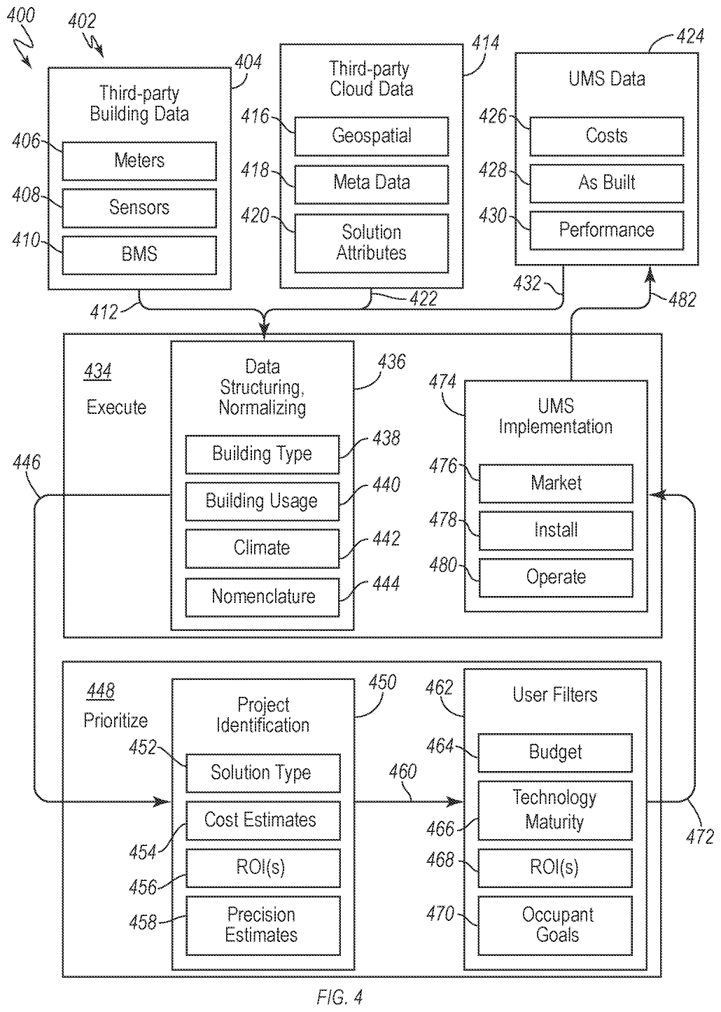

FIG. 4 is a flowchart illustrating a method 400 of operation for a UMS, according to another embodiment of the present disclosure. The method 400 comprises a cyclical logic 402 and/or pattern. The method 400 entails a plurality of data comprising third-party building data 404, third-party cloud data 414, and UMS data 424. The third-party building data 404, generally, represents historical operation of a building (or other facility). The third-party building data 404 may be acquired from a variety of sources (e.g., utility companies, service providers, etc.). The third-party building data 404 may comprise data from meters 406 (e.g., utility meters, submeters, etc.), sensors 408, and the BMS 410. The third-party building data 404 may further comprise data such as, e.g., physical dimensions of the building, usage of the building, age of the building, etc. The third-party building data 404 may also comprise ownership-related data which may identify appropriate decisionmakers who may be involved in determining to adopt a proposal designed by the UMS 101.

The third-party cloud data 414 may comprise geospatial data 416, property meta-data 418, solution attribute data 420, etc. The geospatial data 416 may be acquired from any of a variety of sources, such as Google Maps™ mapping service, a geographic information system (“GIS”) mapping service, county assessor GIS or other data maps or physical maps, etc., mobile mapping applications, mobile measuring applications, mobile GIS applications, etc. The property meta-data may comprise data related or similar to geospatial data, and may be sourced from, e.g., commercial real estate websites, commercial real estate applications, county assessors, etc.

The solution attribute data 420 may comprise utility and incentive data, as well as general and particularized data regarding components presented in a proposal generated by the UMS, such as specifications, restrictions, installation requirements and/or guidance, power consumption, water usage, service requirements, manufacturer MTBF, estimated ATBF particularized to the building, etc. The relevant item data for the one or more facility items can further include specifications (i.e., equipment or fixture specifications) for at least the one or more facility items that comprise operational equipment, the specifications provided by a manufacturer of each facility item to describe its physical and operational characteristics (i.e., how it is designed to perform/operate). The relevant item data for the one or more facility items can further include integrations for at least the one or more facility items that comprise operational equipment, and the integrations of each facility item to describe how it integrates to other facility items. The utility and incentive data may comprise information regarding utility providers, utility rates (current and historical), tariffs, private incentives and/or rebates, government-sponsored incentives and/or rebates, etc. The solution attribute data 420 can also include cost data such as component acquisition cost, component installation cost, component lifetime maintenance cost, etc. The solution attribute data 420 may further include property value of the property as currently built, property value after installation, impact of the UMS-generated proposal on property value over time, etc.

The UMS data 424 can include cost data 426, as-built data 428 (project actuals), and performance data 430. The cost data 426 may comprise project estimates, such as data about the cost of an entire proposal generated by the UMS, cost of portions of the proposal, cost of a particular system in the proposal, etc., to a granular level such as individual component cost. The cost data 426 may comprise energy data, such as an estimate of energy required to implement a proposal generated by the UMS, and the cost of the energy estimated for the implementation, and may be reflected as an overall estimate or an estimate at any level or stage, including granularly to individual subsystems or components, etc. The cost data 426 may also comprise data related to available incentives, which may include value of an incentive, program requirements for an incentive, timing matters related to an incentive, value of the incentive in the project, value of the incentive in property value, etc. The cost data 426 may also comprise equipment data, such as, e.g., particular equipment required for implementing all or a portion of the proposal, cost of acquiring (purchase, lease, rent) the equipment, value of the equipment over time (when purchased), cost of operating the equipment, etc. The cost data 426 may further comprise property value data, such as the property value before and after implementing a proposal generated by the UMS, and the property value in the future (with and without implementing the proposal).

The as-built data 428 may comprise project actual cost data corresponding to data of the project estimates and reflecting the actual affect. By way of non-limiting example, the cost data 426 may contain a price of a widget based on pre-acquisition data, while the as-built data 428 may reflect an actual acquisition cost of the widget. In other words, the cost data 426 may include an estimate to purchase one widget for $100, and the as-built data 428 may reflect an actual cost of $99.05 at time of purchase. Similarly, the as-built data 428 may reflect application of an incentive as realized, which may vary (or be absent) from any incentives in the cost data 426. The as-built data 428 may be updated in real time or near-real time as materials are purchased, expenses are invoiced/paid, etc., and may permit a user to view the actual expenses of a project to date, as well as updated completion costs. The cost data 426 and as-built data 428 may be integrated such that the cost data 426 may be updated in real time as the as-built data 428 are acquired.

The as-built data 428 may further comprise data regarding the building historically, at a present moment, or at a future time. In other words, the as-built data 428 may reflect the building as it exists prior to implementing a proposal generated by the UMS, the building as it exists at a particular moment during implementation of a proposal, or the building as it exists upon completion of the proposal. Furthermore, the as-built data 428 may be updated as maintenance is performed during or after implementation of a proposal generated by the UMS, or as any future proposal generated by the UMS is implemented. The as-built data 428 may also be updated when a natural event, e.g., a major storm, an earthquake, etc., degrades any portion of the building.

The performance data 430 may comprise data reflecting operation of systems, subsystems, components, etc. of the building, including maintenance and replacement costs incurred over time. The performance data 430 may acquire data over time to establish ATBF for components as installed at the building, and further may be used to establish or update a maintenance schedule. The performance data 430 may also be used by the UMS to assess maturity of technology present in systems, subsystems, or components installed to the building. Information about the maturity of a technology as used in the building may be beneficial in assessing the technology for a future proposal to be generated by the UMS for the building, or for a proposal for another facility. The performance data 430 may be utilized to validate or improve on date related to ROI(s) (see the ROI(s) 456, 468 below), and may further facilitate development of a future proposal to be generated by the UMS.

The third-party building data 404, the third-party cloud data 414, and the UMS data 424 may be acquired 412, 422, 432, respectively, by the UMS to commence generation of an upgrade proposal, and at intervals as appropriate. Some data comprising the third-party building data 404, the third-party cloud data 414, or the UMS data 424 may be acquired at fixed intervals, or on a demand basis, or may be automatically acquired in real time or near-real time. The UMS performs (executes) 434 transformation of the third-party building data 404, the third-party cloud data 414, and the UMS data 424 through data structuring and normalizing 436. Data structuring and normalizing 436 may comprise parsing the acquired data 404, 414, 424 to a sufficiently granular level to permit corelating the granular data and generating meaningful data structures 438-444 in support of creating and implementing a proposal. By way of non-limiting example, one or more of the actual operational cost of facility operation and the value proposition for performing the corresponding action may be compared to either (i) a total actual operational cost of the facility to a total anticipated operational cost of the facility OR (ii) an actual operational cost of the corresponding facility items to which pertains the implemented actions to the value proposition for performing the action.

The meaningful data structures 438-444 may be intermediate stages in transforming the acquired data 404, 414, 424 into one or more proposals for the building 10. Such meaningful data structures 438-444 may comprise building type data structure(s) 438, building usage data structure(s) 440, climate data structure(s) 442, and nomenclature data structure(s) 444. Hereafter, “data structures” or “data structure(s)” may be referred to in the singular; however, the disclosure anticipates that a plurality is inherently incorporated to the reference.

The building type data structure 438 may reflect physical characteristics of the building 10, such as number of stories, height of each story, height of the building, underground stories and structures of the building, footprint shape of the building 10, footprint dimensions of the building 10, distinctive footprint shape and dimensions for any story of the building 10, construction style of the building 10, construction materials of the building 10, insulation and/or insulative impact of construction materials of the building 10, etc. The building usage data structure 440 may comprise data related to how the building 10 is used. The building usage data structure 440 may reflect the degree of occupancy of the building 10 as a whole, or in particular portions; may reflect hours of occupancy (e.g., Monday-Friday 7 AM to 7 PM, etc.), variations in occupancy (for example, due to holidays, etc.), the nature of the usage (for example, a bakery in a portion of the building 10, with its concordant power, computing, and gas usage; a law office in another portion of the building 10 with a different concordant power, computing, and gas usage; etc.), variations in traffic within the building, etc.

The climate data structure 442 may comprise data related to climatology for a region wherein the building 10 is sited. The climate data structure 442, more particularly, may comprise data regarding climate variations seasonally, as well as over protracted periods of time.

The nomenclature data structure 444 may comprise data that identifies various components, including facility items, or aspects of the building 10, in particular when such components or aspects may be identified by varied data as acquired from the various sources 404, 414, 424. In other words, the nomenclature data structure 444 may, for example, relate “widget” from one data source 404, 414, 424 and “Widget” from within the same or a different data source 404, 414, 424 as representing the same component. Similarly, the nomenclature data structure 444 may relate “00036891c” from one data source 404, 414, 424 and “gizmo” from the same or a different data source 404, 414, 424. Likewise, the nomenclature data structure 444 may relate a term such as “125V20 A” found in one data source 404, 414, 424, with a term such as “20 amps/125V” found in the same or another data source 404, 414, 424. In other words, the nomenclature data structure 444 may derive a relation or relationship between identifiers, characteristics, and/or other data related to like components, facility items, characteristics, features, etc. found in the various data sources 404, 414, 424.

The UMS data 424 may contain data that is not related to the building 10, but which may become related to the building. By way of example without limitation, the UMS data 424 may comprise a library of electrical components which may or may not be installed to, or even installable to the building. The UMS, in transforming the data acquired from the various sources 404, 414, 424, to generate a proposal, may select some electrical components from the library of electrical components to incorporate into a proposal for the building based, at least in part, on the data structuring and normalizing 436. By way of a related and non-limiting example, the UMS may comprise data of the same sorts as acquired from the various data sources 404, 414, 424, but related to one or more different facilities. The UMS may compare various data from the data sources 404, 414, 424 for the building with appropriate data from other facilities in order to assess the viability and utility of incorporating particular components in a proposal for the building. The comparison of data from one or more other facilities may be accomplished while ensuring any proprietary information is not comprised.

From the data structuring and normalizing 436, the UMS may begin 446 to prioritize 448 elements of a proposal for the building. The UMS performs project identification 450. Project identification 450 comprises identifying a solution type 452, cost estimates 454, ROI(s) 456, and precision estimates 458. The solution type 452 represents the nature of the solution generated by the UMS based on the transformation accomplished through data structuring and normalizing 436 of the data from the various data sources 404, 414, 424. A nature of a solution may, for example, comprise replacing components of a single system, or replacing multiple systems completely, a combination of replacing some components and wholly replacing one or more systems, etc. For purposes of the present disclosure, “replacement” includes such concepts as retrofit, refit, upgrade, new-install, etc. A system replacement may comprise removal of a system (or multiple systems) and installing a replacement system (or multiple replacement systems) wherein the replacement system(s) may be one or more of newer, more compact, more efficient, less expensive to operate, etc., systems. In another example, a nature of a solution may comprise enhancing or supplementing one or more components, such as by adding a new features or component to complement the one or more components.

Additionally, through the transformation of the data structuring and normalizing 436, the UMS may determine particular components to use in a proposal, along with a number and arrangement of the components. Furthermore, the UMS may ascertain a cost of acquiring and installing each of the components, whereby a cost of implementing a proposal can be determined. The cost of implementation may be reflected in the cost estimates 454. The cost estimates 454 comprise granular data and may be rendered to a user at the granular level, or at an overall level, or at any intermediate level. Along with the cost estimates 454, the UMS may further calculate one or more cashflows and associated financial metrics (such as ROIs 456, resiliency, low/high maintenance, and non-direct benefits like employee comfort/productivity) based on the proposal. In a first instance, the UMS may calculate an ROI 456 based on implementing no proposal. In a second instance, the UMS may calculate an ROI 456 based on implementing the complete proposal generated by the UMS. In another instance, the UMS may calculate an ROI 456 based on partial implementation of the proposal. Furthermore, ROIs 456 may be calculated at intervals in the future. Additionally, the UMS may generate alternatives wherein a proposal comprises selecting from a plurality of options, such as components of a first type and components of a second type, and the UMS may calculate ROIs 456 based on each alternative within the proposal. Similarly, the UMS may generate a plurality of proposals for the building and may calculate ROIs 456 based on each proposal of the plurality of proposals. When combined with maturity of technology, the ROIs 456 calculated by the UMS may assist an appropriate decisionmaker to assess the ROIs in light of risk acceptance or aversion in order to select a proposal.

Through transformation of the data during the data structuring and normalizing 436, the UMS is able to generate precision estimates 458 for the proposal, or for each proposal of a plurality of proposals for the building. A precision estimate 458 may comprise granular data for each component, such as cost of acquisition, cost of installation, and cost of operation; and may further comprise any ancillary costs (e.g., licensing, permitting, etc.) whereby the precision estimate 458 reflects an accurate cost for implementation of the particular proposal, and for operation of the building following implementation of the proposal.

Once the project identification 450 is complete, the UMS may apply, or permit a user to apply 460 user filters 462, which represents a second phase of prioritizing 448. The user filters 462 comprise budget filters 464, technology maturity filters 466, ROI(s) filters 468, and occupant goals filters 470. The budget filters 464 may allow rendering of particularized data related to budgetary concerns. The budget filters 464 may be applied at varying levels of granularity whereby an appropriate decisionmaker may view budget information based on various aspects of the proposal. By way of non-limiting example, a budget filter 464 may permit rendering of human-related costs (e.g., labor costs, liability insurance costs, personnel costs by role, etc.), rendering of component costs by system (e.g., computing systems, HVAC systems, electrical systems, etc.), administrative costs (e.g., permitting, licensing, accounting, etc.), and more. The technology maturity filters 466 may permit rendering of a proposal, or portions of a proposal based on a degree to which technologies within the proposal have achieved manufacturer's performance expectations, market penetration, market compliance, etc. In one embodiment, the technology maturity filters 466 may be configurable to render all proposed technologies based on a degree of maturity. In one embodiment, the technology maturity filters 466 may be configurable to render all proposed technologies of the proposal along with an indicator of maturity. The technology maturity filters 466 and the budget filters 464, in one embodiment, may be relatable whereby budgetary aspects of the proposal may be rendered by selection of technology maturity.

In one embodiment, the ROI(s) filters 468 may be configurable to render a variety of ROIs to assist an appropriate decisionmaker in choosing to implement a proposal generated by the UMS. For example, in one configuration, an ROI filter 468 may render the current value and future values of the building without implementation of a proposal, and, in another configuration, to render current and future values of the building based on full implementation of a proposal. The ROI(s) filters 468 may be further configurable to render various ROI(s) based on different costs of money scenarios, different completion dates, utility incentives and/or rebates, value of a utility as a unit of exchange, etc. The ROI(s) filters 468 may be further configurable to the user, e.g., an owner of the building, a lease holder, an occupant, an investor, etc.

The occupant goals filters 470 may permit rendering of aspects of the proposal based on objectives of occupants. For purposes of the present disclosure, the term “occupant” encompasses any form of legal ownership or legal occupancy, e.g., owner in fee simple, owner-in-part or in the entirety, lease holder, sublet, etc. Since the objectives of an occupant may vary by the nature of occupancy or ownership, the occupant goals filters 470 may permit rendering of aspects of the proposal based on the occupant's nature of ownership or occupancy. In other words, an owner of the property may be interested in a 10-year ROI, while a lease holder may be interested in net costs over a 3-year lease term, etc. Furthermore, each occupant's objectives may be served by a alternative in a proposal, or an alternate proposal. The occupant goals filters 470 may permit rendering of a proposal, or aspect of a proposal, or alternate proposals based on the objectives of the various occupants of the building.

The user filters 462 enable 472 UMS implementation 474, representing a second phase of the execution 434 element of the UMS. The UMS implementation 474 comprises marketing 476, installation 478, and operation 480. The marketing 476 comprises performance of renderings of data described above in a form suitable for each user of the UMS. More particularly, the marketing 476 comprises interfacing with contractors and vendors and appropriate decisionmakers. The contractors and vendors may use the marketing 476 to facilitate acquisition of components for installation in accordance with the proposal, to confirm installation schedules(s), as well as to indicate to the UMS progress of implementation of the proposal. By way of non-limiting example, the first contractor may employ the marketing 476 in acquiring components, equipment, labor, etc., to confirm installation schedule(s), or to request modification of an installation schedule if, e.g., some components are delayed in delivery; and may further employ the marketing 476 to indicate to the UMS progress in completing installation. The UMS, as described above, may employ updates in progress of completion to update the status of the proposal whereby each user may become apprised of the progress. Extending the foregoing example, when the second contractor is contracted to perform an installation that is dependent on an installation by the first contractor, the second contractor may become apprised via the marketing 476 of readiness to begin work. The marketing 476 may also serve to provide a prospectus (see the prospectus 116 in FIG. 1) for an appropriate decisionmaker whereby the appropriate decisionmaker may become sufficiently informed to accept the proposal. The prospectus, based on the transformation of data occurring principally at the data structuring and normalizing 436, may become configured to present the proposal, including variations of the proposal or alternate proposals in sufficient detail, even to a granular level, to enable the appropriate decisionmaker to adopt a proposal for implementation.

The installation 478 may enable updating the digital twin, which, in turn, may enable updating each child digital twin (see the digital twin 130 and child digital twins 130c, 130d in FIG. 2) whereby each user may become informed of the current state of progress or completion of the proposal. Furthermore, the installation 478 may access the relational data structures (see the relational data structures 140 in FIG. 2) and/or other portions of the UMS, to facilitate rendering the current state of the building 10 at any time; and may update the relational data structures 140 in real time or near-real time whereby each of the relational data structures of each user may be updated. The installation 478 may acquire data regarding completion (or partial completion), etc., via input from the contractors and vendors.

The operation 480 within the UMS implementation 474 may acquire data regarding the completion (or partial completion) of the proposal whereby the UMS may begin to acquire data about the performance of installed components. The operation 480 on an ongoing basis may acquire data regarding installed components over time, and may comprise data regarding resource consumption (e.g., electrical power consumption), failure data, etc. The operation 480 may enable the UMS to develop ATBF as installed to the building, better or more comprehensive technology maturity data, etc., whereby the UMS may perform comparative analyses with regard to future proposals for the building or other facilities.

The UMS implementation 474 provides 482 input for the UMS data 424, establishing a circular logic 402 for the UMS. In particular, the circular logic 402 enables the UMS to provide forward-looking data regarding the building, such as may relate to maintenance, ROI(s), property value over time, a future proposal for the building, etc. The circular logic 402 may further enable the UMS in developing proposals for other facilities having at least some characteristics comparable to the building, the value of a utility resource as a unit of exchange, providing bases for assessing technology maturity and assisting technology maturation by identifying appropriate candidates for installation of a particular technology, etc.

FIG. 5 is logical communication diagram for a facility management system 501 (referred to herein as “UMS 501”), according to an embodiment of the present disclosure, and which may be similar in many respects to the UMS 101 of FIGS. 1-2. The UMS 501 comprises a computing system 510, a tablet 512, a prospectus 516, a first contractor 518c, a second contractor 518d, and a vendor 518e, each of which may be similar in many respects to their respective analogs 110, 112, 116, 118c, 118d, and 118e in FIGS. 1 and 2. The computing system 510 comprises a DTGE 520, a DTOE 522, a proposal engine 524, and an installation management engine (hereafter, “IME”) 526, a product recommendation engine (“PRE”) 528, and an interface engine 540. The computing system 510 further comprises a network communication interface 530 (or simply network interface).

As described elsewhere herein, the DTGE 520 generates a logical representation of the building (e.g., the building 10 in FIG. 1) or other facility. The DTOE 522 facilitates the DTGE 520 in maintaining a current-state representation of the building as systems, subsystems, components, etc. at the building change (e.g., modified, replaced, etc.). In other words, the DTOE 522 may acquire a present operation condition of the facility wherein the present operation condition may include a newly designed or installed or implemented facility item.

The proposal engine 524 may generate a proposal for modifying, replacing, updating, etc., systems, subsystems, components, etc., of the building. The proposal engine 524 may draw upon the DTGE 520, the DTOE 522, and other aspects of the UMS 501 to generate the proposal, potentially in the form of an electronic prospectus 516. The proposal engine 524 may further facilitate acceptance of the proposal by an appropriate decisionmaker whereby the proposal moves into an implementation phase.

The IME 526 may be configured to receive approval for the proposal. The IME 526 may be configured to place the proposal into an implementation state when authorized by an appropriate decisionmaker, or to place the proposal in a “hold” (or wait state) when directed by the appropriate decisionmaker, etc. The IME 526 may also cause delivery of particular portions of the proposal to appropriate contractors and vendors 518c-518e. (More or fewer than three contractors and vendors may be involved in a proposal, and the three contractors and vendors 518c-518e serve to represent any number of contractors and vendors.) Stated otherwise, the IME 526 may be configured to instruct implementation of the action of one or more recommendations of the set of one or more recommendations of the proposal, according to the approval of the proposal received from the point of contact for the facility.

Furthermore, the IME 526 may be configured to acquire data regarding the completion of partial completion of the proposal or any phase of the proposal, whereby at least the DTOE 522 may be updated in order to facilitate updating other aspects of the UMS 501 and the proposal. The IME 526 may be configured to receive verification of implementation of the action of the one or more recommendations of the set of one or more recommendations of the proposal wherein the DTOE 522 updates the digital representation to reflect the implemented action of the one or more recommendations of the set of one or more recommendations of the proposal. The IME 526 may be configured to receive verification (e.g., user input such as an installation contractor, a point of contact, etc.) of performance of the action of the one or more recommendations of the set of one or more recommendations of the proposal, and enabling the DTGE 520 and DTOE 522 to update the digital representation so that the digital representation reflects the performed (implemented) action of the one or more recommendations of the set of one or more recommendations of the proposal.

The network communication interface 530 may comprise any of hardware logic, firmware logic, and software logic whereby the network communication interface 530 is configured (and configurable) to facilitate communication between various components (logical and physical) of the UMS 501, and with external entities such as an appropriate decisionmaker for the building 10, contractors and vendors 518c-518e, sales representatives, etc. The network communication interface 530 may comprise one or more network interface cards (“NICs”) installed at the computer system 510, and may further comprise a separate computer integrated to the UMS 501 and configured to manage network traffic. Furthermore, the network interface 530 may comprise one or more security implementations, such as, e.g., a firewall, packet scanner, protocol management, etc. In one embodiment, the network communication interface 530 may comprise an internal communication component and an external communication component. The internal communication component may be particularly configured to transmit network communication between internal components of the UMS 501, such as, e.g., the DTGE 520, the DTOE 522, the proposal engine 524, and the IME 526. The external communication component may be particularly configured to transmit network communication between the internal components of the UMS 501 and external entities such as the BMS 16, the tablet 512, the prospectus 516 (an appropriate decisionmaker), and the contractors and vendors 518c-518e.

The interface engine 540 may be configured to generate user-specific user interfaces (“UI”) 541-546 for each user of the UMS 501. Each UI 541-546 may be configured to display, render, or otherwise present data from the UMS 501 appropriate to the user, and to receive input from the user and to send the input to the UMS 501. For example, the UI 541 may be particularly configured for performing a site survey of the building 10 using the tablet 512. The UI 542 may be configured to present the prospectus 516 to the appropriate decisionmaker, and to receive input from the appropriate decisionmaker. The UI 544 may be configured to render the child digital twin and RDS (see the child digital twin 130c and RDS 140c in FIG. 2) for the first contractor 518c and receive input from the first contractor 518c for transmission to the UMS 501. Similarly, the UI 543 may be configured for a user of a the BMS 16; the UI 545 may be configured for a second contractor 518d; and the UI 546 may be configured for a vendor 518e. The UIs 544-546 may be functionally similar or even identical; however, because the UMS 501 sends particularized data to each contractor and vendor 518c-518e, the individual UIs 544-546 may render differently from each other, or may simply render different representations for each particular contractor and vendor 518c-518e. Furthermore, each UI 541-546 may be configured to accept input from a user comprising selection of a component or facility item for use in the proposal, and/or for entering data regarding a component or facility use. Said otherwise, the interface engine may provide a user interface to a client computing device (e.g., tablet 512), the user interface providing functionality to receive, via the user interface, additional relevant item data (to revise, augment, or update digital representation of facility items) to update the digital representation of the facility; present to a user the visualization of the facility; to access live product information from one or more vendors through a marketplace, and to select a product to be included as one of a new facility item or upgrade facility item in a proposal for the facility. The user interface, further, may permit rendering to a display of client computing device one or more live products from which a selection may be made, via a user input, to choose from the one or more live products a product as new facility item or an upgrade facility for a proposal.

The PRE 528 may be configured to employ the various data acquired regarding the building, to identify potential candidates for use in a proposal for the building. More particularly, the PRE 528 may be configured to identify products recommended (by a manufacturer, vendor, contractor, etc.) to be incorporated as a facility item in a facility such as the facility for the UMS 501 in generating a proposal. Identified products can include tangible goods, intangible goods (e.g., software) and services, and anything offered for sale or license and combinations or sets of thereof. Stated differently, identified products can include anything that can be a component of a facility to potentially improve, enhance, supplement, upgrade, replace, retrofit, modify, and maintain and existing facility item of the facility. The UMS 501 may acquire data relating to components, as described in conjunction with FIG. 2, et seq., during preparation of a proposal for the building, and over time as proposals are prepared for other facilities. These data may be incorporated into a library of components for consideration as facility items in a proposal for any facility. The PRE 528 may employ the library of components to recommend candidates to be used as facility items in a proposal for the building. In other words, the PRE 528 may be configured to identify recommended products to be incorporated as a facility item in the facility. The library of components may contain data relative to a facility item (component) presently or previously used in the building, and may further contain data relative to an analog, updated version, replacement version, or upgrade component related to the facility item presently installed. Facility items in the building may include both operational components and systems (such as HVAC, elevator, lighting, etc.) and non-operational components (such as flooring, ceiling tiles, wall covering, etc.). Information for analogs for both operational and non-operational components may be stored in the library of components. The one or more facility items include both operational facility items (i.e., operate to perform a function, e.g., HVAC, lighting,) and nonoperational facility items (i.e., do not operate—i.e., window, tile flooring, a staircase).

The PRE 528 may be configured to identify each component from the component library that represents an appropriate analog, update, replacement, or upgrade for the facility item. In other words, at least one facility item of the facility items comprises facility equipment relevant to operation of the facility and the historical operating conditions and present operating conditions include operating conditions of the facility equipment.

While the present disclosure has explicitly described embodiments related to the building 10, the disclosure anticipates that a facility for which proposals may be generated under an embodiment may entail a facility with more than one structure. Furthermore, the one or more structures situated upon a physical site may include that one or more structures that may be manmade artifices other than a building (e.g., a power transmission structure, a water moving or lifting structure, a lighting facility for an outdoor area of the site, an athletic field with its accompanying accoutrement, etc.). Stated otherwise, the facility may comprise one or more structures and a site upon which the one or more structures are constructed.

### EXAMPLES

Example 1. A system of facility management comprising: an interface to a communication network to communicate over a network with a facility; a non-transitory memory; one or more processors in electrical communication with the memory and to receive and transmit data via the communication interface; a digital representation generation engine comprising hardware logic to generate an accurate digital representation of the facility, including to: receive map data of a facility, the map data including plan data providing a layout of the facility and relevant item data that provides facility items, including a location of each facility item within the layout of the facility; receive historical operational data providing historical operating conditions of the facility, including the one or more facility items; and convert the map data and historical operational data into the digital representation of the facility; and a digital representation operation engine comprising hardware logic to: receive live operational data providing present operating conditions of the facility; update the digital representation of the facility with the present operating conditions of the facility to ensure the digital representation continues to accurately represent the facility; and provide a digital, three-dimensional (3D) visualization of the facility to a user to present to the user the layout of the facility, the one or more facility items, and operating conditions of the facility.

Example 2. The system of example 1, wherein the facility comprises one or more structures and a site upon which the one or more structures are constructed.

Example 3. The system of example 2, wherein the facility comprises equipment positioned on the site (e.g., external to the structures).

Example 4. The system of example 1, wherein the layout of the facility comprises a floor plan of a structure of the facility.

Example 5. The system of example 4, wherein the layout of the facility further comprises a site plan (e.g., map of the site) of a site on which the structure of the facility is constructed.

Example 6. The system of example 1, further comprising: a proposal engine to: generate a proposal for the facility, the proposal comprising a set of one or more recommendations each pertaining to one or more corresponding facility items, each recommendation comprising an action to be implemented (e.g., performed) in relation to the one or more corresponding facility items and a value proposition for implementing (e.g., performing) the action; and transmit the proposal to a human facility point of contact.

Example 7. The system of example 6, further comprising: an installation management engine to: receive approval of the proposal (e.g., from the human facility point of contact); instruct implementation of the action of one or more recommendations of the set of one or more recommendations of the proposal, according to the approval of the proposal received from the point of contact for the facility; and receive verification of implementation of the action of the one or more recommendations of the set of one or more recommendations of the proposal, wherein the digital representations operational engine updates the digital representation to reflect the implemented action of the one or more recommendations of the set of one or more recommendations of the proposal.

Example 8. The system of example 7, wherein the operating conditions include one of an actual operational cost of facility operation and data from which the actual operational cost can be derived, wherein the proposal engine is further configured to: compare the actual operational cost of facility operation to the value proposition for implementing the corresponding action; and one or more of: generate a subsequent proposal based in part on information from the comparing the actual operational cost of facility operation to the value proposition for implementing the action to improve a recommendation, including a value proposition for performing or implementing an action, in the subsequent proposal; and transmit a report to the point of contact for the facility providing a result of the comparison of the actual operational cost of facility operation to the value proposition for implementing the corresponding action.

Example 9. The system of example 6, wherein the action of a recommendation comprises one or more of improving, upgrading, replacing, retrofitting, modifying, and maintaining the facility item to which the recommendation pertains.

Example 10. The system of example 1, further comprising: an interface engine to provide a user interface to a client computing device, the user interface providing functionality to: receive, via the user interface, additional relevant item data to revise/update/augment digital representations of facility items to update the digital representation of the facility; present to a user the visualization of the facility; access live product information from one or more vendors through a marketplace; and select a product to be included as one of a new facility item or upgrade facility item in a proposal for the facility.

Example 11. The system of example 10, further comprising a product recommendation engine to identify recommended products to be incorporated as a facility item in the facility.

Example 12. The system of example 1, wherein at least one facility item of the facility items comprises facility equipment relevant to operation of the facility, where the historical operating conditions and present operating conditions include operating condition of the facility equipment.

Example 13. A computer implemented method of managing a facility, comprising: receiving map data of an existing facility (i.e., a place comprising at least a physical structure constructed and/or installed for an activity or to serve a function), the map data including plan data providing a layout of the facility and relevant item data for one or more facility items, including a location of each of the one or more facility items within the layout of the facility; receiving historical operational data (e.g., usage; hours of operation, control schemes, energy consumption) providing historical operating conditions of the facility (potentially up to the present moment), including the one or more facility items; converting the map data and historical operational data into a digital representation of the facility; receiving live operational data providing present (or current or updated) operating conditions of the facility; updating the digital representation of the facility with the present operating conditions of the facility (and the new designed facility item) to ensure the digital representation continues to provide accurate representation of the facility; and providing a digital, three-dimensional (3D) visualization of the facility to a user, the visualization generated from the digital representation, the visualization to present or render to the user the layout of the facility, the one or more facility items, and operating conditions of the facility.

Example 14. The method of example 13, wherein the relevant item data for the one or more facility items further includes specification (i.e., equipment specifications) for at least the one or more facility items that comprise operation equipment, the specification provided by a manufacturer of each facility item to describe its physical and operational characteristics (i.e., how the facility item is designed or intended to perform/operate).

Example 15. The method of example 13, wherein the relevant item data for the one or more facility items further includes integrations for at least the one or more facility items that comprise operational equipment, the integrations of each facility item to describe how it integrate to other facility items.

Example 16. The method of example 13, wherein the one or more facility items include both operational facility items (i.e. operate to perform a function, e.g., HVAC, lighting,) and nonoperational facility items (i.e., do not operate, e.g., window, tile flooring, a staircase).

Example 17. The method of example 13, wherein the facility comprises one or more structures and a site upon which the one or more structures are constructed.

Example 18. The method of example 13, wherein the layout of the facility comprises a floor plan of a structure of the facility.

Example 19. The method of example 18, wherein the layout of the facility further comprises a reflected ceiling plan of the structure.

Example 20. The method of example 13, further comprising: generating a proposal for the facility, the proposal comprising a set of one or more recommendations each pertaining to one or more corresponding facility items, each recommendation comprising an action to be performed or implemented in relation to the one or more corresponding facility items and a value proposition for performing or implementing the action; and transmitting the proposal to a human point of contact for the facility.

Example 21. The method of example 20, further comprising: receiving approval of the proposal from the human point of contact of the facility; and instructing performance or implementation of the action of one or more recommendations of the set of one or more recommendations of the proposal, according to the approval of the proposal received from the point of contact for the facility.

Example 22. The method of example 21, further comprising: receiving verification (e.g., user input (from an installation contractor, from the point of contact, etc.)) of performance of the action of the one or more recommendations of the set of one or more recommendations of the proposal, wherein updating the digital representation includes updating the digital representation to reflect the performed or implemented action of the one or more recommendations of the set of one or more recommendations of the proposal.

Example 23. The method of example 22, wherein the operating conditions include one of an actual operational cost of facility operation and data from which the actual operational cost of facility operation can be derived, the method further comprising: comparing the actual operational cost of facility operation to the value proposition for performing or implementing the corresponding action; and one or more of: generating a subsequent proposal based in part on information from the comparing the actual operational cost of facility operation to the value proposition for performing or implementing the action to improve a recommendation, including a value proposition for performing implementing an action, in the subsequent proposal; and transmitting a report to the point of contact for the facility providing a result of the comparing.

Example 24. The method of example 23, wherein the actual operational cost of facility operation comprises a sum of operation costs of all facility items.

Example 25. The method of example 23, wherein the actual operational cost of facility operation comprises an operational cost of the one or more corresponding facility items of the proposal.

Example 26. The method of example 23, wherein the comparing comprises normalizing one or more of the actual operational cost of facility operation and the value proposition for performing or implementing the corresponding action to compare either a total actual operational cost of the facility (i.e. a sum of operational costs of all facility items) to a total anticipated operational cost of the facility (i.e., a sum of operational costs of all facility items with the value proposition integrated) OR an actual operational cost of the corresponding facility items to which pertains the implemented actions to the value proposition for performing the action.

Example 27. The method of example 20, wherein the action of a recommendation comprises one or more of improving, upgrading, replacing, retrofitting, modifying, and maintaining the facility item to which the recommendation pertains.

Example 28. The method of example 20, wherein the one or more corresponding facility items includes one or more of an operational facility item and a nonoperational facility item.

Example 29. The method of example 20, wherein the action comprises doing nothing (e.g., because the facility item is presently performing or otherwise within an optimal or desired state).

Example 30. The method of example 13, further comprising: providing a user interface to a client computing device (e.g., tablet, smartphone, laptop, etc.) over a communication network, the user interface providing functionality to: receive, via the user interface, additional relevant item data to revise/update/augment digital representations of facility items to update the digital representation of the facility; present to a user the three-dimensional (3D) visualization of the facility; access live product information from one or more vendors through a marketplace; view one or more recommended products to be incorporated as a facility item in the facility; and select a product to be included as one of a new facility item or upgrade facility item in a proposal for the facility.

Example 31. The method of example 13, wherein a facility item of the one or more facility items comprises facility equipment relevant to operation of the facility, where the historical operating conditions and present operating conditions include operating conditions of the facility equipment.

Example 32. The method of example 13, wherein the one or more facility items include one or more of areas of interest and facility equipment.

Example 33. The method example 13, wherein the one or more facility equipment includes fixtures (e.g., a lighting fixture, router, photovoltaic panel—i.e., fixtures are an example of equipment).

Example 34. The method of example 13, wherein the relevant item data for the one or more facility items further includes operational system information describing a collection of facility items performing an operation of a facility (e.g., HVAC system).

Example 35. The method of example 13, further comprising: transforming the digital representation of the facility into a design stage digital model of the facility (e.g., BIM).

Example 36. The method of example 13, further comprising: generating the visualization of the facility from the digital representation and/or the digital model.

Example 37. The method of example 35, further comprising: generating the visualization of the facility from the digital representation and/or the digital model.

Example 38. A system of facility management, comprising: a communication network interface to communicate over a network with a facility; one or more processors to receive and transmit data via the communication interface; a non-transitory memory having stored thereon instructions that, when executed by the one or more processors, cause the processor to perform operations to enhance facility management, the operations to receive map data of a facility, the map data including plan data providing a layout of the facility and relevant item data for one or more facility items, including a location of each of the one or more facility items within the layout of the facility; receive historical operational data providing historical operating conditions of the facility, including the one or more facility items; convert the map data and historical operational data into a digital representation of the facility; receive live operational data providing present operating conditions of the facility; update the digital representation of the facility with the present operating conditions of the facility to ensure the digital representation continues to provide an accurate representation of the facility; and provide a digital, three-dimensional (3D) visualization of the facility to a user, the visualization generated from the digital representation, the visualization to present or render to the user the layout of the facility, the one or more facility items, and operating conditions of the facility.

Example 39. A computer implemented method of managing a facility, comprising: receiving map data of an existing facility, including a site upon which one or more structures of the facility are built, the map data including plan data of the facility providing a layout of the facility and relevant item data for facility items relevant to operation of the facility, the relevant item data including a location of each of the facility items within the layout of the facility, the facility items comprising operational facility items and non-operational items and including areas of interest and facility equipment; receiving historical operational data providing historical operating conditions of the facility equipment; converting the map data and historical operational data into a digital representation of the facility; providing a visualization of the facility to a user, the visualization generated from the digital representation, the visualization presenting a floor plan, a reflected ceiling plan, the facility items, and the operating conditions of the facility equipment; receiving live operational data providing current operating conditions of the facility equipment; updating the digital representation of the facility with the current operating conditions of the facility equipment; and providing a revised visualization of the facility according to the current operating conditions of the facility equipment

Example 40. The method of example 39, further comprising: generating a proposal for the facility, the proposal comprising a set of one or more recommendations each pertaining to one or more corresponding facility items, each recommendation comprising an action to be implemented in relation to the one or more corresponding facility items and a value proposition for implementing the action; transmitting the proposal to a facility point of contact; receiving approval of the proposal from the facility point of contact; instructing performance of the action of one or more recommendations of the set of one or more recommendations of the proposal, according to the approval of the proposal received from the facility point of contact; and receiving verification of performance of the action of the one or more recommendations of the set of one or more recommendations of the proposal, wherein updating the digital representation includes updating the digital representation to reflect the implemented action of the one or more recommendations of the set of one or more recommendations of the proposal.

Example 41. A method of providing a digital representation of a facility, comprising: receiving map data of a facility, the map data including plan data providing a layout of the facility and relevant item data of facility items, including a location of each of the facility items within the layout of the facility; receiving operational data providing operating conditions of the facility, including the facility items, generating an accurate digital representation of the facility based on the map data and the operational data; receiving ongoing operational data providing current operating conditions of the facility; maintaining accuracy of the digital representation of the facility based on the current operating conditions of the facility provided in the ongoing operational data; providing a visualization of the facility to a user, the visualization generated from the digital representation, the visualization to present to the user the layout of the facility, the facility items, and current operating conditions of the facility.

Example 42. A computer implemented method of managing facility comprising: receiving live operational data providing current operating conditions of facility equipment; updating a digital representation of the facility with the current operating conditions of the facility with the current operating condition of the facility equipment; and generating a revised visualization of the facility according to the current operating conditions of the facility equipment; wherein the digital representation is obtained through conversion, prior to receiving the live operation data, of: map data of the facility including plan data of the facility and relevant item data that provides facility items relevant to operation of the facility; and historical operation data providing historical operating conditions of the facility equipment.

It will be obvious to those having skill in the art that many changes may be made to the details of the above-described embodiments without departing from the underlying principles of the invention. The scope of the present invention should, therefore, be determined only by the following claim.

1. A system of facility management, comprising:
a network interface to communicate over a network with a facility;
memory;
one or more processors in electrical communication with the memory and to receive and transmit data via the communication interface;
a digital representation generation engine to generate an accurate digital representation of the facility, including to:
receive map data of a facility, the map data including plan data providing a layout of the facility and relevant item data for one or more facility items, including a location of each facility item within the layout of the facility;
receive historical operational data providing historical operating conditions of the facility, including the one or more facility items; and
convert the map data and historical operational data into the digital representation of the facility; and
a digital representation operation engine to:
receive live operational data providing present operating conditions of the facility;
update the digital representation of the facility with the present operating conditions of the facility to ensure the digital representation continues to accurately represent the facility; and
provide a visualization of the facility to a user to present to the user the layout of the facility, the one or more facility items, and operating conditions of the facility.

2. The system of claim 1, wherein the facility comprises one or more structures and a site upon which the one or more structures are constructed.

3. The system of claim 1, wherein the layout of the facility comprises a floor plan of a structure of the facility.

4. The system of claim 1, further comprising:
a proposal engine to:
generate a proposal for the facility, the proposal comprising a set of one or more recommendations each pertaining to one or more corresponding facility items, each recommendation comprising an action to be implemented in relation to the one or more corresponding facility items and a value proposition for implementing the action; and
transmit the proposal to a human facility point of contact.

5. The system of claim 4, further comprising:
an installation management engine to:
receive approval of the proposal;
instruct implementation of the action of one or more recommendations of the set of one or more recommendations of the proposal, according to the approval of the proposal received from the point of contact for the facility; and
receive verification of implementation of the action of the one or more recommendations of the set of one or more recommendations of the proposal,
wherein the digital representation operation engine updates the digital representation to reflect the implemented action of the one or more recommendations of the set of one or more recommendations of the proposal.

6. The system of claim 5, wherein the operating conditions include one of an actual operational cost of facility operation and data from which the actual operational cost of facility operation can be derived,
wherein the proposal engine is further configured to:
compare the actual operational cost of facility operation to the value proposition for implementing the corresponding action; and
one or more of:
i) generate a subsequent proposal based in part on information from the comparing the actual operational cost of facility operation to the value proposition for implementing the action to improve a recommendation in the subsequent proposal; and
ii) transmit a report to the point of contact for the facility providing a result of the comparison of the actual operational cost of facility operation to the value proposition for implementing the corresponding action.

7. The system of claim 4, wherein the action of a recommendation comprises one or more of improving, upgrading, replacing, retrofitting, modifying, and maintaining the facility item to which the recommendation pertains.

8. The system of claim 1, further comprising:
an interface engine to provide a user interface to a client computing device, the user interface providing functionality to:
receive, via the user interface, additional relevant item data to update the digital representation of the facility;
present to a user the visualization of the facility;
access live product information from one or more vendors through a marketplace; and
select a product to be included as one of a new facility item or upgrade facility item in a proposal for the facility.

9. The system of claim 8, further comprising a product recommendation engine to identify recommended products to be incorporated as a facility item in the facility.

10. The system of claim 1, wherein at least one facility item of the facility items comprises facility equipment relevant to operation of the facility,
where the historical operating conditions and present operating conditions include operating conditions of the facility equipment.

11. A computer implemented method of managing a facility, comprising:
receiving map data of a facility, the map data including plan data providing a layout of the facility and relevant item data for one or more facility items, including a location of each of the one or more facility items within the layout of the facility;
receiving historical operational data providing historical operating conditions of the facility, including the one or more facility items;
converting the map data and historical operational data into a digital representation of the facility;
receiving live operational data providing present operating conditions of the facility;
updating the digital representation of the facility with the present operating conditions of the facility to ensure the digital representation continues to provide accurate representation of the facility; and
providing a visualization of the facility to a user, the visualization generated from the digital representation, the visualization to present to the user the layout of the facility, the one or more facility items, and operating conditions of the facility.

12. The method of claim 11, wherein the facility comprises one or more structures and a site upon which the one or more structures are constructed.

13. The method of claim 11, wherein the layout of the facility comprises a floor plan of a structure of the facility.

14. The method of claim 11, further comprising:
generating a proposal for the facility, the proposal comprising a set of one or more recommendations each pertaining to one or more corresponding facility items, each recommendation comprising an action to be performed in relation to the one or more corresponding facility items and a value proposition for performing the action; and
transmitting the proposal to a human point of contact for the facility.

15. The method of claim 14, further comprising:
receiving approval of the proposal; and
instructing performance of the action of one or more recommendations of the set of one or more recommendations of the proposal, according to the approval of the proposal received from the point of contact for the facility.

16. The method of claim 15, further comprising:
receiving verification of performance of the action of the one or more recommendations of the set of one or more recommendations of the proposal,
wherein updating the digital representation includes updating the digital representation to reflect the performed action of the one or more recommendations of the set of one or more recommendations of the proposal.

17. The method of claim 16, wherein the operating conditions include one of an actual operational cost of facility operation and data from which the actual operational cost of facility operation can be derived, the method further comprising:
comparing the actual operational cost of facility operation to the value proposition for performing the corresponding action; and
one or more of:
i) generating a subsequent proposal based in part on information from the comparing the actual operational cost of facility operation to the value proposition for performing the action to improve a recommendation in the subsequent proposal; and
ii) transmitting a report to the point of contact for the facility providing a result of the comparing.

18. The method of claim 14, wherein the action of a recommendation comprises one or more of improving, upgrading, replacing, retrofitting, modifying, and maintaining the facility item to which the recommendation pertains.

19. The method of claim 11, further comprising:
providing a user interface to a client computing device, the user interface providing functionality to:
receive, via the user interface, additional relevant item data to update the digital representation of the facility;
present to a user the visualization of the facility;
access live product information from one or more vendors through a marketplace; and
select a product to be included as one of a new facility item or upgrade facility item in a proposal for the facility.

20. The method of claim 11, wherein a facility item of the one or more facility items comprises facility equipment relevant to operation of the facility,
where the historical operating conditions and present operating conditions include operating conditions of the facility equipment.
